(19) United States
(12) Patent Application Publication
(10) Pub. No.: US 2025/0056476 A1
(43) Pub. Date: Feb. 13, 2025

(54) METHOD FOR ENHANCING SL POSITIONING WITH PAST MEASUREMENTS

(71) Applicant: Nokia Technologies Oy, Espoo (FI)

(72) Inventors: Stepan KUCERA, Munich (DE); Diomidis MICHALOPOULOS, Munich (DE); Prajwal KESHAVAMURTHY, Munich (DE); Taylan SAHIN, Munich (DE)

(21) Appl. No.: 18/792,469

(22) Filed: Aug. 1, 2024

Related U.S. Application Data
(60) Provisional application No. 63/531,865, filed on Aug. 10, 2023.

(51) Int. Cl. H04W 64/00; H04L 5/00; H04W 92/18

(52) U.S. Cl. CPC H04W 64/00; H04L 5/0051; H04W 92/18

(57) ABSTRACT

An apparatus configured to: obtain at least one positioning reference signal measurement, wherein the at least one positioning reference signal measurement comprises at least one of: a positioning reference signal measurement from a session-less positioning process, a positioning reference signal measurement from a past positioning process, or a positioning reference signal measurement from a parallel positioning process; and determine one of: the at least one obtained positioning reference signal measurement, or an indication of the at least one obtained positioning reference signal measurement for use in a positioning process for the apparatus.

### TECHNICAL FIELD

The example and non-limiting embodiments relate generally to UE positioning and, more particularly, to the sidelink LTE positioning protocol (SLPP).

### BACKGROUND

It is known, in UE positioning, to perform one of session-based positioning or session-less positioning.

### SUMMARY

The following summary is merely intended to be illustrative. The summary is not intended to limit the scope of the claims.

In accordance with one aspect, an apparatus comprising: at least one processor; and at least one memory storing instructions that, when executed by the at least one processor, cause the apparatus at least to: obtain at least one positioning reference signal measurement, wherein the at least one positioning reference signal measurement comprises at least one of: a positioning reference signal measurement from a session-less positioning process, a positioning reference signal measurement from a past positioning process, or a positioning reference signal measurement from a parallel positioning process; and determine one of: the at least one obtained positioning reference signal measurement, or an indication of the at least one obtained positioning reference signal measurement for use in a positioning process for the apparatus.

In accordance with one aspect, a method comprising: obtaining, with a user equipment, at least one positioning reference signal measurement, wherein the at least one positioning reference signal measurement comprises at least one of: a positioning reference signal measurement from a session-less positioning process, a positioning reference signal measurement from a past positioning process, or a positioning reference signal measurement from a parallel positioning process; and determining one of: the at least one obtained positioning reference signal measurement, or an indication of the at least one obtained positioning reference signal measurement for use in a positioning process for the user equipment.

In accordance with one aspect, an apparatus comprising means for: obtaining at least one positioning reference signal measurement, wherein the at least one positioning reference signal measurement comprises at least one of: a positioning reference signal measurement from a session-less positioning process, a positioning reference signal measurement from a past positioning process, or a positioning reference signal measurement from a parallel positioning process; and determining one of: the at least one obtained positioning reference signal measurement, or an indication of the at least one obtained positioning reference signal measurement for use in a positioning process for the apparatus.

In accordance with one aspect, a non-transitory computer-readable medium comprising program instructions stored thereon for performing at least the following: causing obtaining of at least one positioning reference signal measurement, wherein the at least one positioning reference signal measurement comprises at least one of: a positioning reference signal measurement from a session-less positioning process, a positioning reference signal measurement from a past positioning process, or a positioning reference signal measurement from a parallel positioning process; and determining one of: the at least one obtained positioning reference signal measurement, or an indication of the at least one obtained positioning reference signal measurement for use in a positioning process for the user equipment.

In accordance with one aspect, an apparatus comprising: at least one processor; and at least one memory storing instructions that, when executed by the at least one processor, cause the apparatus at least to: obtain at least one positioning reference signal measurement, wherein the at least one positioning reference signal measurement comprises at least one of: positioning reference signal measurement from a session-less positioning process, a positioning reference signal measurement from a past positioning process, or a positioning reference signal measurement from a parallel positioning process; and cause a user equipment to determine one of: the at least one obtained positioning reference signal measurement, or an indication of the at least one obtained positioning reference signal measurement for use in a positioning process for the user equipment.

In accordance with one aspect, a method comprising: obtaining, with a positioning management entity, at least one positioning reference signal measurement, wherein the at least one positioning reference signal measurement comprises at least one of: a positioning reference signal measurement from a session-less positioning process, a positioning reference signal measurement from a past positioning process, or a positioning reference signal measurement from a parallel positioning process; and causing a user equipment to determine one of: the at least one obtained positioning reference signal measurement, or an indication of the at least one obtained positioning reference signal measurement for use in a positioning process for the user equipment.

In accordance with one aspect, an apparatus comprising means for: obtaining at least one positioning reference signal measurement, wherein the at least one positioning reference signal measurement comprises at least one of: a positioning reference signal measurement from a session-less positioning process, a positioning reference signal measurement from a past positioning process, or a positioning reference signal measurement from a parallel positioning process; and causing a user equipment to determine one of: the at least one obtained positioning reference signal measurement, or an indication of the at least one obtained positioning reference signal measurement for use in a positioning process for the user equipment.

In accordance with one aspect, a non-transitory computer-readable medium comprising program instructions stored thereon for performing at least the following: causing obtaining of at least one positioning reference signal measurement, wherein the at least one positioning reference signal measurement comprises at least one of: a positioning reference signal measurement from a session-less positioning process, a positioning reference signal measurement from a past positioning process, or a positioning reference signal measurement from a parallel positioning process; and causing a user equipment to determine one of: the at least one obtained positioning reference signal measurement, or an indication of the at least one obtained positioning reference signal measurement for use in a positioning process for the user equipment.

In accordance with one aspect, an apparatus comprising: at least one processor; and at least one memory storing instructions that, when executed by the at least one processor, cause the apparatus at least to: determine that at least one positioning reference signal measurement is not available, wherein the at least one positioning reference signal measurement comprises at least one of: a positioning reference signal measurement from a session-less positioning process, a positioning reference signal measurement from a past positioning process, or a positioning reference signal measurement from a parallel positioning process; and transmit an indication that the at least one positioning reference signal measurement is not available to at least one of: a target user equipment, a network node, a location management function, a server user equipment, a further user equipment, or a positioning management entity.

In accordance with one aspect, a method comprising: determining, with an apparatus, that at least one positioning reference signal measurement is not available, wherein the at least one positioning reference signal measurement comprises at least one of: a positioning reference signal measurement from a session-less positioning process, a positioning reference signal measurement from a past positioning process, or a positioning reference signal measurement from a parallel positioning process; and transmitting an indication that the at least one positioning reference signal measurement is not available to at least one of: a target user equipment, a network node, a location management function, a server user equipment, a further user equipment, or a positioning management entity.

In accordance with one aspect, an apparatus comprising means for: determining that at least one positioning reference signal measurement is not available, wherein the at least one positioning reference signal measurement comprises at least one of: a positioning reference signal measurement from a session-less positioning process, a positioning reference signal measurement from a past positioning process, or a positioning reference signal measurement from a parallel positioning process; and transmitting an indication that the at least one positioning reference signal measurement is not available to at least one of: a target user equipment, a network node, a location management function, a server user equipment, a further user equipment, or a positioning management entity.

In accordance with one aspect, a non-transitory computer-readable medium comprising program instructions stored thereon for performing at least the following: determining, with an apparatus, that at least one positioning reference signal measurement is not available, wherein the at least one positioning reference signal measurement comprises at least one of: a positioning reference signal measurement from a session-less positioning process, a positioning reference signal measurement from a past positioning process, or a positioning reference signal measurement from a parallel positioning process; and causing transmitting of an indication that the at least one positioning reference signal measurement is not available to at least one of: a target user equipment, a network node, a location management function, a server user equipment, a further user equipment, or a positioning management entity.

In accordance with one aspect, an apparatus comprising: at least one processor; and at least one memory storing instructions that, when executed by the at least one processor, cause the apparatus at least to: determine that a positioning process of a target user equipment is changed; and obtain at least one positioning reference signal measurement associated with the target user equipment, wherein the at least one positioning reference signal measurement comprises at least one of: a positioning reference signal measurement from a session-less positioning process, a positioning reference signal measurement from a past positioning process, or a positioning reference signal measurement from a parallel positioning process.

In accordance with one aspect, a method comprising: determining, with a server user equipment, that a positioning process of a target user equipment is changed; and obtaining at least one positioning reference signal measurement associated with the target user equipment, wherein the at least one positioning reference signal measurement comprises at least one of: a positioning reference signal measurement from a session-less positioning process, a positioning reference signal measurement from a past positioning process, or a positioning reference signal measurement from a parallel positioning process.

In accordance with one aspect, an apparatus comprising means for: determining that a positioning process of a target user equipment is changed; and obtaining at least one positioning reference signal measurement associated with the target user equipment, wherein the at least one positioning reference signal measurement comprises at least one of: a positioning reference signal measurement from a session-less positioning process, a positioning reference signal measurement from a past positioning process, or a positioning reference signal measurement from a parallel positioning process.

In accordance with one aspect, a non-transitory computer-readable medium comprising program instructions stored thereon for performing at least the following: determining that a positioning process of a target user equipment is changed; and causing obtaining of at least one positioning reference signal measurement associated with the target user equipment, wherein the at least one positioning reference signal measurement comprises at least one of: a positioning reference signal measurement from a session-less positioning process, a positioning reference signal measurement from a past positioning process, or a positioning reference signal measurement from a parallel positioning process.

According to some aspects, there is provided the subject matter of the independent claims. Some further aspects are defined in the dependent claims.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a diagram illustrating features as described herein;

FIG. 3 is a diagram illustrating features as described herein;

FIG. 4 is a flowchart illustrating steps as described herein;

FIG. 5 is a flowchart illustrating steps as described herein;

FIG. 6 is a flowchart illustrating steps as described herein; and

FIG. 7 is a flowchart illustrating steps as described herein.

### DETAILED DESCRIPTION OF EMBODIMENTS

The following abbreviations that may be found in the specification and/or the drawing figures are defined as follows:
3GPP third generation partnership project
5G fifth generation
5GC 5G core network
A-IoT ambient Internet of Things
AMF access and mobility management function
CE control element
CRAN cloud radio access network
CU central unit
D2D device-to-device
DU distributed unit
ECID enhanced cell identified
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
GDOP geometric dilution of precision
gNB (or gNodeB) base station for 5G/NR, i.e., a node providing NR user plane and control plane protocol terminations towards the UE, and connected via the NG interface to the 5GC
GNSS global navigation satellite system
I/F interface
IoT Internet of Things
L1 layer 1
LMF location management function
LOS line of sight
LPP LTE positioning protocol
LTE long term evolution
MAC medium access control
MME mobility management entity
MO-LR mobile-originated localization request
Msg message
MT-LR mobile-terminated localization request
ng or NG new generation
ng-eNB or NG-eNB new generation eNB
NLOS non-line of sight
NR new radio
NRPPa NR positioning protocol A
N/W or NW network
OOC out of coverage
O-RAN open radio access network
PCI physical cell identifier
PDCP packet data convergence protocol
PHY physical layer
ProSe proximity service
PRS positioning reference signal
RACH random access channel
RAN radio access network
RF radio frequency
RLC radio link control
RRC radio resource control
RRH remote radio head
RRM radio resource management
RS reference signal
RSU road-side unit
RTT round-trip time
RU radio unit
Rx receiver
SDAP service data adaptation protocol
SDT small data transmission
SGW serving gateway
SL sidelink
SLPP sidelink LTE positioning protocol
SMF session management function
SRS sounding reference signal
TA timing advance
TDoA time difference of arrival
TRP transmission reception point
Tx transmitter
UE user equipment (e.g., a wireless, typically mobile device)
UPF user plane function
V2N vehicle to network
V2P vehicle to pedestrian
V2V vehicle to vehicle
V2X vehicle to everything
VNR virtualized network function

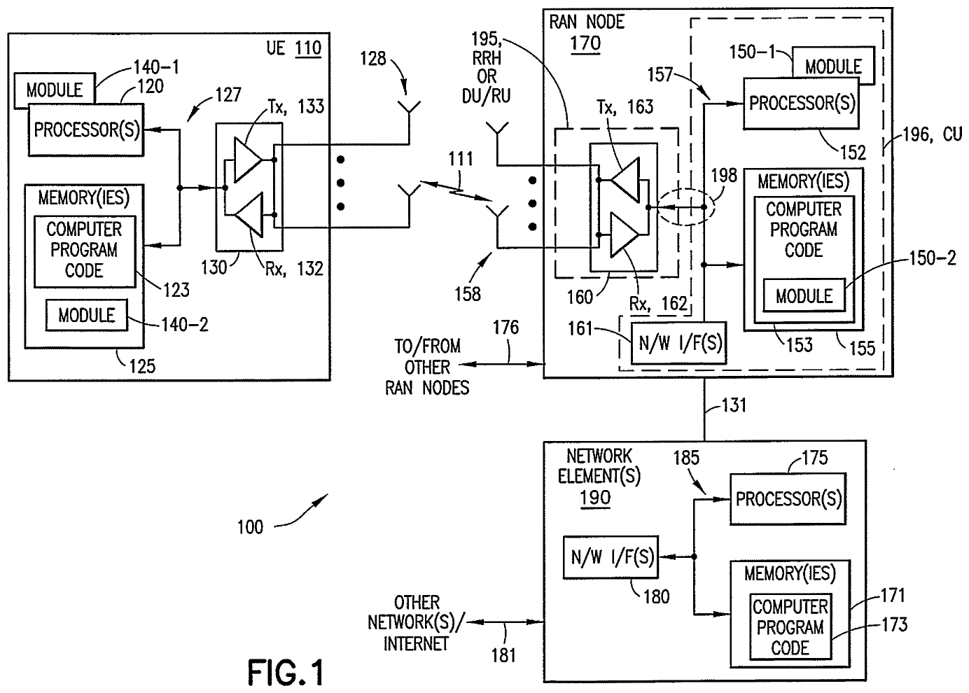

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. A “circuit” may include dedicated hardware or hardware in association with software executable thereon. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station, access point, access node, or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely illustrative functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. For example, a network may be deployed in a tele cloud, with virtualized network functions (VNF) running on, for example, data center servers. For example, network core functions and/or radio access network(s) (e.g. CloudRAN, O-RAN, edge cloud) may be virtualized. Note that the virtualized entities that result from the network virtualization are still implemented, at some level, using hardware such as processors 152 or 175 and memories 155 and 171, and also such virtualized entities create technical effects.

It may also be noted that operations of example embodiments of the present disclosure may be carried out by a plurality of cooperating devices (e.g. cRAN).

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Having thus introduced one suitable but non-limiting technical context for the practice of the example embodiments of the present disclosure, example embodiments will now be described with greater specificity.

Features as described herein may generally relate to, while not being limited to, new radio (NR) sidelink (SL) enhancements. For example, NR SL methods may be implemented to provide communication between a vehicle and a network, infrastructure(s), other vehicle(s), or other road user(s) in the surrounding/immediate area. Such communication may enable proximity service (ProSe), or transmission of information about the surrounding environment, between devices in close proximity, for example device-to-device (D2D) communication technology. Such direct communication may be available even when network coverage is unavailable. Additionally or alternatively, NR SL methods may be implemented in scenarios unrelated to traffic users, such as public safety scenarios and/or commercial scenarios.

Additionally or alternatively, NR SL methods may relate to Internet of Things (IoT) and automotive industries (e.g., for reduction of accident risk and safer driving experiences). These use cases may include a message exchange among vehicles (V2V), vehicles and pedestrians (V2P), vehicles and infrastructure (V21) and vehicles and networks (V2N), and may be referred to as vehicle-to-everything (V2X). Sidelink may use the same or different carrier frequencies or frequency bands than cellular communication.

Enhancements to sidelink procedures may be applicable in these V2X and other use cases. Enhancements to sidelink procedures may be applicable to unicast, groupcast, multicast, and/or broadcast procedures.

Additionally or alternatively, NR SL methods may relate to ambient Internet of Things (IoT) devices. Ambient IoT devices may be described as low power devices, low cost devices, and/or as devices with limited functionality/processing capability. An example of an ambient IoT (A-IoT) device is a passive radio, which may harness energy from wireless signals sent on specific carriers and/or bandwidths and charge a simple circuitry that, once activated, may emit/reflect a signal, which may encode at least the ID of the passive radio. The typical system architecture around a passive radio consists of an activator, a passive radio, and a reader. The activator is a device that sends an activation signal targeted at waking up the passive radio. The passive radio harnesses energy over a range of frequencies and listens for activation signals. Once such a signal is detected, the passive radio emits/reflects a signal which is specific to that radio ID. The reader is a device that listens and detects the passive radio signals. The reader may or may not be collocated with the activator. Other examples of A-IoT devices include semi-passive devices and battery-less devices. A-IoT devices may be used, for example, for indoor/outdoor positioning. In the present disclosure, the term anchor devices may be used, and may include anchor A-IoT devices, low cost simplified mobile devices, IoT devices, etc.

Features as described herein may generally relate to 5G NR positioning such as the LTE positioning protocol (LPP) and the sidelink LTE positioning protocol (SLPP), for example as studied by 3GPP in the Enhanced positioning WI of Release 18. In legacy positioning, a UE is positioned within a single dedicated positioning process during which all required PRS measurements are collected and processed. The positioning process may be of a session-based or a session-less nature.

In session-based SL positioning, a dedicated positioning session is setup by a controlling node (e.g. the location management function (LMF) or the server UE) by using specific LPP/SLPP signaling. Session members are selected such that positioning requirements are met (e.g. minimum achievable accuracy thanks to favorable geometric dilution of precision (GDOP) of selected anchors) and once configured, all session members commit to following the configuration and protocols.

In session-less positioning, the goal is to avoid the overhead and latency stemming from the above-mentioned session setup and maintenance. Only best-effort positioning service is provided, primarily concerning UEs capable of self-positioning based on simple overhearing of PRS from near-by active anchor UEs. In general, LPP/SLPP communications with the network/peers are kept to a minimum (e.g. only anchor absolute location may be requested, if not advertised publicly, via e.g. discovery messages) and no reliability provisions such as SLPP re-transmissions are typically made.

Whenever a new session is established for a target UE, the positioning management entity (e.g. LMF, server UE or target UE) itself needs to configure anchor UEs and target UE to transmit/receive SL positioning reference signals (PRS), conduct positioning related measurements, and further report them to the managing entity for the positioning estimation calculation, which requires a sequence of signaling steps between the involved entities, resulting in increased latency.

However, if the target UE or the managing entity already has measurements collected in the past or from a concurrent, also known as parallel, positioning procedure, which are relevant to positioning the target UE (e.g. from another session or from session-less positioning), these measurements may be reused, thus removing/reducing the need for any new measurements to be configured and conducted. As a result, the positioning process can be improved in terms of signaling efficiency; however, there is currently no mechanism in the specs that allow for signaling efficiency by means of reusing measurements.

When starting a new positioning process (be it of a session-based or a session-less nature), it would be beneficial to reuse already existing PRS measurements collected in the past, for example in anticipation of this new positioning process or as part of other previous positioning processes. Past measurements provide additional spatial diversity information that generally improves the overall positioning quality (i.e. accuracy). For example, a UE engaged in session-less self-positioning may realize that quick and simple overhearing of SL PRS may not lead to sufficiently accurate results (i.e. the results may be determined to be inaccurate), and may decide to trigger session-based positioning in which all the previously acquired “session-less” SL PRS measurements may be reused. Vice versa, a UE leaving LMF coverage may be given a full report on anchor “session-based” measurement so that it can start a session-less self-positioning process once in out-of-coverage conditions.

A technical effect of example embodiments of the present disclosure may be to cover the existing gap in the specs with respect to reuse of measurements towards signaling efficiency.

In an example embodiment, any PRS measurements may be reused between two consecutive or concurrent/parallel positioning processes. In an example embodiment, information from a past/concurrent positioning process (e.g. the associated (SL) PRS measurements) may be provided to initialize a new positioning process, be it of a session-based or a session-less nature.

In an example embodiment, there may be an indication that such information (e.g. measurement info) is (not) available (e.g. at the target UE or the LMF). In an example embodiment, there may be a request to provide such information (e.g. between the target UE and the LMF). In an example embodiment, there may be provisioning of such information (e.g. in conjunction with additional information describing the measurement type and configuration). Examples of measurement type may include a positioning method the measurement is used for. For example, for TDoA, the measurement type is time of arrival (or time difference of arrival), that is time-measurement. For Angle of Departure, the measurement type is beam-specific Reference Signal Received Power (RSRP), that is power-measurement.

In an example embodiment, there may be acceptance/rejection of such information (e.g. measurements from selected anchors may be accepted), together with (optional) acknowledgement. In an example embodiment, a new positioning process may be configured with respect to the provided information (e.g. only complementary anchors may be selected as part of the new process, but provided past data may be used).

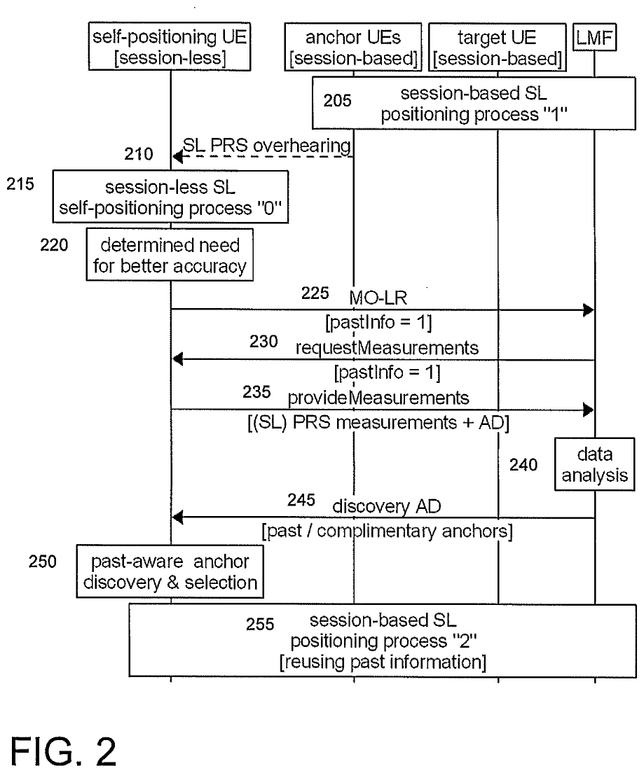

Referring now to FIG. 2, illustrated is an example of Inheritance of (SL) PRS measurements from past session-less self-positioning process by new session-based positioning process.

At 205, it may be assumed that the LMF is engaged in a session-based SL positioning process “1” involving a target UE and several anchor UEs. At 210, a self-positioning UE may overhear the transmitted SL PRS and, at 215, use them for its own self-localization purposes (process “0”). At 220, in parallel, it may be determined by the self-positioning UE that the resulting accuracy is not sufficient (i.e. the accuracy does not meet certain requirements, is less than/below a (predetermined) threshold, etc.), and that there is a need for more reliable session-based positioning. In other words, the UE may determine that at least one requirement for the accuracy is not met, or is failed. Examples of requirements for the accuracy may include requirements for achieved positioning accuracy in the horizontal plane, and/or requirements for achieved positioning accuracy in the vertical plane. For example, a requirement may be met if the achievable accuracy on the horizontal (or vertical) plane is larger than or equal to XXX (centi)-meters. The requirement may not be met if less than a predetermined accuracy on the horizontal (or vertical) plane is determined/achieved.

To this end, at 225 the self-positioning UE may issue a mobile-originated localization request (MO-LR) to the LMF while indicating that past SL PRS measurements are available (e.g. by raising a dedicated binary flag “pastInformationAvailable=1”). The LMF, if interested, may then at 230 formally request the measurements (e.g. by sending the “requestMeasurement” message with raised flag “pastInformationAvailable =1”). At 235, the self-positioning UE may then reply with a “provideMeasurements” message containing the past measurements as well as the necessary additional information associated with the measurements (e.g. SL PRS config/resource, session ID (if available), SL PRS sequence ID, measurement quality per SL PRS sequence ID, measurement type, and/or transmit UE parameters such as identity).

While in the example of FIG. 2 the MO-LR is transmitted to the LMF, this is not limiting; an indication that past/concurrent SL PRS measurement(s) are available at the UE may be transmitted to a positioning entity such as a network node, a positioning management entity, a further UE, or a server UE.

At 240, the LMF may perform data analysis of the received measurements and/or additional information. The LMF may choose to accept some of the measurements as the seeding information of the new session-based positioning process “1” and, at 245, may request the self-positioning UE to proceed with the discovery of the appropriate anchor UE(s). These anchor UEs may be required to be complimentary to the ones reported in the “provideMeasurements” information message to ensure anchor diversity and avoid measurement duplication (i.e. not repeating measurements that are included in the set of past/concurrent measurements). In another example, some or all past anchors may be re-selected to calibrate past sidelink time difference of arrival (SL-TDoA) results to new measurements (e.g. to offset synchronization error between past and new anchors).

At 250, the self-positioning UE may proceed with the selective discovery process and report the results. At 255, the LMF may then continue with the session-based positioning process “2” during which the provided past SL PRS measurements are reused. For example, the UE may initialize or (re)configure the session-based positioning process. For example, the UE may provide, to a network or another device/UE, an indication that a past SL PRS measurement is available upon requesting a positioning process.

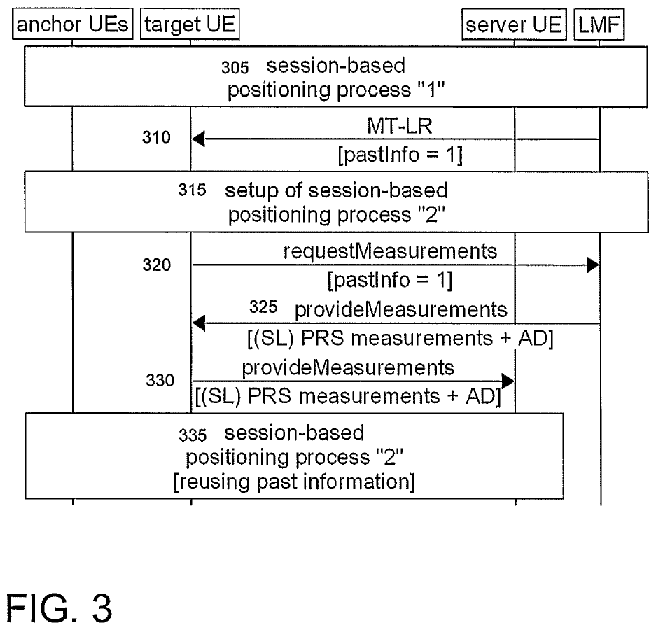

Referring now to FIG. 3, illustrated is an example of inheritance of (SL) PRS measurements from past session-based positioning process by a subsequent session-based positioning process.

In an example embodiment, it may be assumed that the LMF hands over a session to a server UE (e.g. because the target UE is moving out of coverage) and at that occasion all past measurements may be handed over as well to provide for continuity in accurate positioning.

At 305, the initial session-based positioning process “1” may be managed by the LMF. Once the likelihood of an out-of-coverage condition is determined (e.g. based on an explicit indication from the target UE itself as in FIG. 3, or based on the tracking and position extrapolation by the LMF), at 310 a mobile-terminated localization request (MT-LR) may be initiated, whereby the availability of past measurement information may be indicated by raising the “pastInfo” flag to “1”. The MT-LR may be transmitted by the LMF to the target UE. At 315, this may trigger the setup of a new positioning session “2,” whose control the LMF may hand over to a server UE. At 320, the target UE or the server UE may then request the past measurement information. In the example of FIG. 3, it may be the target UE who requests and, at 325, obtains it from the LMF. Subsequently, at 330 the target UE may forward this information to the server UE (unless supporting server UE functionality itself) for further use during the session-based positioning process “2” at 335. For example, the UE may initialize or (re)configure the session-based positioning process. For example, the UE may provide, to a network or another device/UE, an indication that a past SL PRS measurement is available upon requesting a positioning process.

While in the example of FIG. 3 the MT-LR is transmitted with a LMF, this is not limiting; an indication that past/concurrent SL PRS measurement(s) are available may be transmitted from a positioning entity such as a network node, a positioning management entity, a further UE, or a server UE.

In another example embodiment, the LMF may provide the past measurements to the server UE directly (e.g. if it is within reach of LMF) for the process “2”.

It may be noted that FIG. 2 illustrates an example in which the target UE moves from a session-less positioning process, and that FIG. 3 illustrates an example in which the target UE moves from a session-based positioning process to a subsequent session-based positioning process. These examples are not limiting; the target UE may move from a session-based positioning process to a session-less positioning process, for example to save signaling.

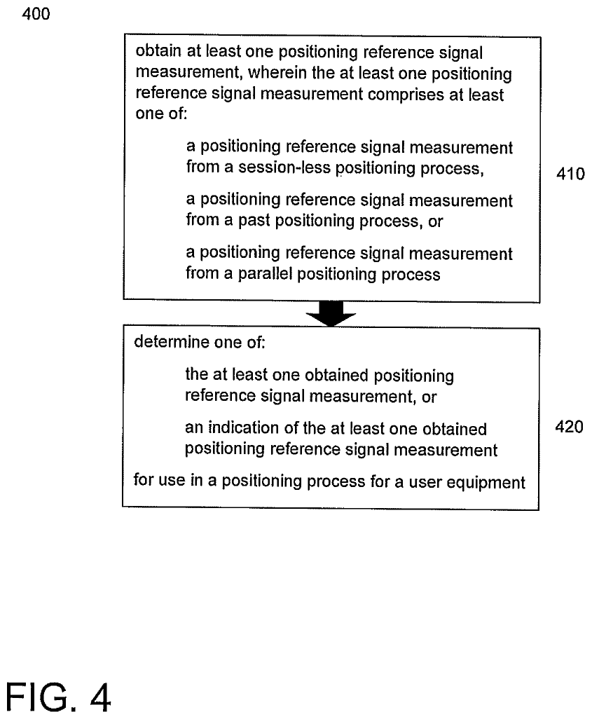

FIG. 4 illustrates the potential steps of an example method 400. The example method 400 may include: obtaining at least one positioning reference signal measurement, wherein the at least one positioning reference signal measurement comprises at least one of: a positioning reference signal measurement from a session-less positioning process, a positioning reference signal measurement from a past positioning process, or a positioning reference signal measurement from a parallel positioning process, 410; and determining one of: the at least one obtained positioning reference signal measurement, or an indication of the at least one obtained positioning reference signal measurement for use in a positioning process for a user equipment, 420. The example method 400 may be performed, for example, with a target UE.

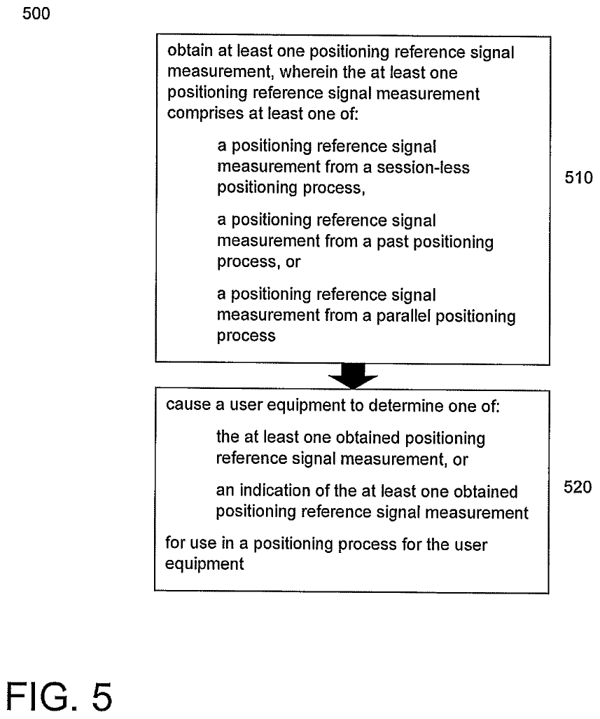

FIG. 5 illustrates the potential steps of an example method 500. The example method 500 may include: obtaining at least one positioning reference signal measurement, wherein the at least one positioning reference signal measurement comprises at least one of: a positioning reference signal measurement from a session-less positioning process, a positioning reference signal measurement from a past positioning process, or a positioning reference signal measurement from a parallel positioning process, 520; and causing a user equipment to determine one of: the at least one obtained positioning reference signal measurement, or an indication of the at least one obtained positioning reference signal measurement for use in a positioning process for the user equipment, 520. The example method 500 may be performed, for example, with a network node, base station, eNB, gNB, LMF, etc.

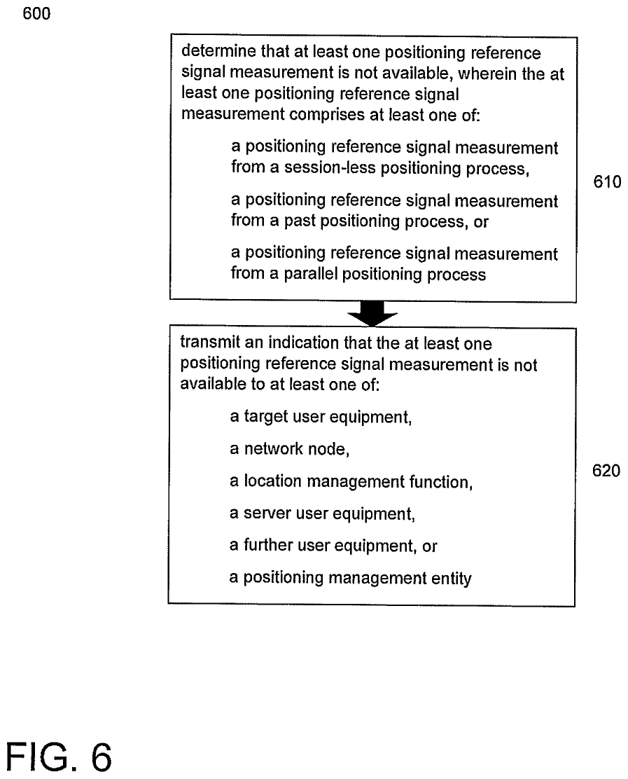

FIG. 6 illustrates the potential steps of an example method 600. The example method 600 may include: determining that at least one positioning reference signal measurement is not available, wherein the at least one positioning reference signal measurement comprises at least one of: a positioning reference signal measurement from a session-less positioning process, a positioning reference signal measurement from a past positioning process, or a positioning reference signal measurement from a parallel positioning process, 610; and transmitting an indication that the at least one positioning reference signal measurement is not available to at least one of: a target user equipment, a network node, a location management function, a server user equipment, a further user equipment, or a positioning management entity, 620. The example method 600 may be performed, for example, with a target UE, a network node, base station, eNB, gNB, LMF, etc.

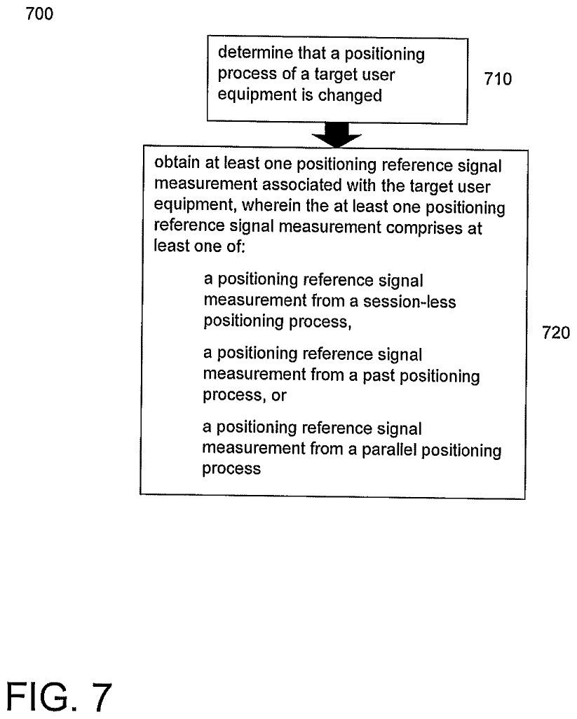

FIG. 7 illustrates the potential steps of an example method 700. The example method 700 may include: determining that a positioning process of a target user equipment is changed, 710; and obtaining at least one positioning reference signal measurement associated with the target user equipment, wherein the at least one positioning reference signal measurement comprises at least one of: a positioning reference signal measurement from a session-less positioning process, a positioning reference signal measurement from a past positioning process, or a positioning reference signal measurement from a parallel positioning process, 720. The example method 700 may be performed, for example, with a server UE.

In accordance with one example embodiment, an apparatus may comprise: at least one processor; and at least one memory storing instructions that, when executed by the at least one processor, cause the apparatus at least to: obtain at least one positioning reference signal measurement, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and determine one of: the at least one obtained positioning reference signal measurement, or an indication of the at least one obtained positioning reference signal measurement for use in a positioning process for the apparatus.

The example apparatus may comprise a sidelink user equipment.

The example apparatus may be further configured to: transmit, to a positioning entity, an indication that the at least one positioning reference signal measurement is available at the apparatus; receive, from the positioning entity, a request to provide the at least one positioning reference signal measurement; and transmit, to the positioning entity, the at least one positioning reference signal measurement.

The positioning entity may comprise at least one of: a network node, a location management function, a server user equipment, a further user equipment, or a positioning management entity.

The example apparatus may be further configured to: receive, from the positioning entity, an acknowledgement of the at least one transmitted positioning reference signal measurement.

The example apparatus may be further configured to: overhear at least one positioning reference signal; perform the session-less positioning process based, at least partially, on the overheard positioning reference signal; and determine that an accuracy of the session-less positioning process does not meet at least one requirement, wherein the indication that the at least one positioning reference signal measurement is available at the apparatus may be transmitted in response to the accuracy of the session-less positioning process not meeting the at least one requirement.

The positioning process may comprise a session-based positioning process.

The example apparatus may be further configured to: transmit, to the positioning entity, additional information associated with the at least one positioning reference signal measurement, wherein the additional information may comprise at least one of: a sidelink positioning reference signal configuration, a sidelink positioning reference signal resource identifier, a session identifier, a sidelink positioning reference signal sequence identifier, a measurement quality per sidelink positioning reference signal sequence identifier, a transmit user equipment parameter, or a measurement type.

The example apparatus may be further configured to: perform a session-based positioning process; receive, from a positioning entity, an indication that the at least one positioning reference signal measurement is available at the network node; transmit, to the positioning entity, a request to provide the at least one positioning reference signal measurement; and receive, from the positioning entity, the at least one positioning reference signal measurement.

The positioning entity may comprise at least one of: a network node, a location management function, a server user equipment, a further user equipment, or a positioning management entity.

The positioning process may comprise a subsequent session-based positioning process.

The positioning process may comprise a session-less positioning process.

The example apparatus may be further configured to: receive, from the positioning entity, additional information associated with the at least one positioning reference signal measurement, wherein the additional information may comprise at least one of: a sidelink positioning reference signal configuration, a sidelink positioning reference signal resource identifier, a session identifier, a sidelink positioning reference signal sequence identifier, a measurement quality per sidelink positioning reference signal sequence identifier, a transmit user equipment parameter, or a measurement type.

The example apparatus may be further configured to: provide the at least one obtained positioning reference signal measurement to a server user equipment.

The example apparatus may be further configured to: transmit, to the positioning entity, an indication that the apparatus is moving out of the coverage of the positioning entity.

The example apparatus may be further configured to: trigger the positioning process based, at least partially, on the at least one obtained positioning reference signal measurement.

The example apparatus may be further configured to: select at least one complementary anchor user equipment based, at least partially, on the at least one obtained positioning reference signal measurement.

The example apparatus may be further configured to: accept one or more of the at least one positioning reference signal measurement; or reject one or more of the at least one positioning reference signal measurement.

In accordance with one aspect, an example method may be provided comprising: obtaining, with a user equipment, at least one positioning reference signal measurement, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and determining one of: the at least one obtained positioning reference signal measurement, or an indication of the at least one obtained positioning reference signal measurement for use in a positioning process for the user equipment.

The user equipment may comprise a sidelink user equipment.

The example method may further comprise: transmitting, to a positioning entity, an indication that the at least one positioning reference signal measurement is available at the user equipment; receiving, from the positioning entity, a request to provide the at least one positioning reference signal measurement; and transmitting, to the positioning entity, the at least one positioning reference signal measurement.

The positioning entity may comprise at least one of: a network node, a location management function, a server user equipment, a further user equipment, or a positioning management entity.

The example method may further comprise: receiving, from the positioning entity, an acknowledgement of the at least one transmitted positioning reference signal measurement.

The example method may further comprise: overhearing at least one positioning reference signal; performing the session-less positioning process based, at least partially, on the overheard positioning reference signal; and determining that an accuracy of the session-less positioning process does not meet at least one requirement, wherein the indication that the at least one positioning reference signal measurement is available at the user equipment may be transmitted in response to the accuracy of the session-less positioning process not meeting the at least one requirement.

The positioning process may comprise a session-based positioning process.

The example method may further comprise: transmitting, to the positioning entity, additional information associated with the at least one positioning reference signal measurement, wherein the additional information may comprise at least one of: a sidelink positioning reference signal configuration, a sidelink positioning reference signal resource identifier, a session identifier, a sidelink positioning reference signal sequence identifier, a measurement quality per sidelink positioning reference signal sequence identifier, a transmit user equipment parameter, or a measurement type.

The example method may further comprise: performing a session-based positioning process; receiving, from a positioning entity, an indication that the at least one positioning reference signal measurement is available at the network node; transmitting, to the positioning entity, a request to provide the at least one positioning reference signal measurement; and receiving, from the positioning entity, the at least one positioning reference signal measurement.

The positioning entity may comprise at least one of: a network node, a location management function, a server user equipment, a further user equipment, or a positioning management entity.

The positioning process may comprise a subsequent session-based positioning process.

The positioning process may comprise a session-less positioning process.

The example method may further comprise: receiving, from the positioning entity, additional information associated with the at least one positioning reference signal measurement, wherein the additional information may comprise at least one of: a sidelink positioning reference signal configuration, a sidelink positioning reference signal resource identifier, a session identifier, a sidelink positioning reference signal sequence identifier, a measurement quality per sidelink positioning reference signal sequence identifier, a transmit user equipment parameter, or a measurement type.

The example method may further comprise: providing the at least one obtained positioning reference signal measurement to a server user equipment.

The example method may further comprise: transmitting, to the positioning entity, an indication that the user equipment is moving out of the coverage of the positioning entity.

The example method may further comprise: triggering the positioning process based, at least partially, on the at least one obtained positioning reference signal measurement.

The example method may further comprise: selecting at least one complementary anchor user equipment based, at least partially, on the at least one obtained positioning reference signal measurement.

The example method may further comprise: accepting one or more of the at least one positioning reference signal measurement; or rejecting one or more of the at least one positioning reference signal measurement.

In accordance with one example embodiment, an apparatus may comprise: circuitry configured to perform: obtaining, with a user equipment, at least one positioning reference signal measurement, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and circuitry configured to perform: determining one of: the at least one obtained positioning reference signal measurement, or an indication of the at least one obtained positioning reference signal measurement for use in a positioning process for the user equipment.

In accordance with one example embodiment, an apparatus may comprise: processing circuitry; memory circuitry including computer program code, the memory circuitry and the computer program code configured to, with the processing circuitry, enable the apparatus to: obtain at least one positioning reference signal measurement, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and determine one of: the at least one obtained positioning reference signal measurement, or an indication of the at least one obtained positioning reference signal measurement for use in a positioning process for the apparatus.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for: obtaining at least one positioning reference signal measurement, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and determining one of: the at least one obtained positioning reference signal measurement, or an indication of the at least one obtained positioning reference signal measurement for use in a positioning process for the apparatus.

The apparatus may comprise a sidelink user equipment.

The means may be further configured for: transmitting, to a positioning entity, an indication that the at least one positioning reference signal measurement is available at the apparatus; receiving, from the positioning entity, a request to provide the at least one positioning reference signal measurement; and transmitting, to the positioning entity, the at least one positioning reference signal measurement.

The positioning entity may comprise at least one of: a network node, a location management function, a server user equipment, a further user equipment, or a positioning management entity.

The means may be further configured for: receiving, from the positioning entity, an acknowledgement of the at least one transmitted positioning reference signal measurement.

The means may be further configured for: overhearing at least one positioning reference signal; performing the session-less positioning process based, at least partially, on the overheard positioning reference signal; and determining that an accuracy of the session-less positioning process does not meet at least one requirement, wherein the indication that the at least one positioning reference signal measurement is available at the apparatus may be transmitted in response to the accuracy of the session-less positioning process not meeting the at least one requirement.

The positioning process may comprise a session-based positioning process.

The means may be further configured for: transmitting, to the positioning entity, additional information associated with the at least one positioning reference signal measurement, wherein the additional information may comprise at least one of: a sidelink positioning reference signal configuration, a sidelink positioning reference signal resource identifier, a session identifier, a sidelink positioning reference signal sequence identifier, a measurement quality per sidelink positioning reference signal sequence identifier, a transmit user equipment parameter, or a measurement type.

The means may be further configured for: performing a session-based positioning process; receiving, from a positioning entity, an indication that the at least one positioning reference signal measurement is available at the network node; transmitting, to the positioning entity, a request to provide the at least one positioning reference signal measurement; and receiving, from the positioning entity, the at least one positioning reference signal measurement.

The positioning entity may comprise at least one of: a network node, a location management function, a server user equipment, a further user equipment, or a positioning management entity.

The positioning process may comprise a subsequent session-based positioning process.

The positioning process may comprise a session-less positioning process.

The means may be further configured for: receiving, from the positioning entity, additional information associated with the at least one positioning reference signal measurement, wherein the additional information may comprise at least one of: a sidelink positioning reference signal configuration, a sidelink positioning reference signal resource identifier, a session identifier, a sidelink positioning reference signal sequence identifier, a measurement quality per sidelink positioning reference signal sequence identifier, a transmit user equipment parameter, or a measurement type.

The means may be further configured for: providing the at least one obtained positioning reference signal measurement to a server user equipment.

The means may be further configured for: transmitting, to the positioning entity, an indication that the apparatus is moving out of the coverage of the positioning entity.

The means may be further configured for: triggering the positioning process based, at least partially, on the at least one obtained positioning reference signal measurement.

The means may be further configured for: selecting at least one complementary anchor user equipment based, at least partially, on the at least one obtained positioning reference signal measurement.

The means may be further configured for: accepting one or more of the at least one positioning reference signal measurement; or rejecting one or more of the at least one positioning reference signal measurement.

A processor, memory, and/or example algorithms (which may be encoded as instructions, program, or code) may be provided as example means for providing or causing performance of operation.

In accordance with one example embodiment, a non-transitory computer-readable medium comprising instructions stored thereon which, when executed with at least one processor, cause the at least one processor to: cause obtaining of at least one positioning reference signal measurement, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and determining one of: the at least one obtained positioning reference signal measurement, or an indication of the at least one obtained positioning reference signal measurement for use in a positioning process for the user equipment.

In accordance with one example embodiment, a non-transitory computer-readable medium comprising program instructions stored thereon for performing at least the following: causing obtaining of at least one positioning reference signal measurement, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and determining one of: the at least one obtained positioning reference signal measurement, or an indication of the at least one obtained positioning reference signal measurement for use in a positioning process for the user equipment.

In accordance with another example embodiment, a non-transitory program storage device readable by a machine may be provided, tangibly embodying instructions executable by the machine for performing operations, the operations comprising: causing obtaining of at least one positioning reference signal measurement, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and determining one of: the at least one obtained positioning reference signal measurement, or an indication of the at least one obtained positioning reference signal measurement for use in a positioning process for the user equipment.

In accordance with another example embodiment, a non-transitory computer-readable medium comprising instructions that, when executed by an apparatus, cause the apparatus to perform at least the following: causing obtaining of at least one positioning reference signal measurement, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and determining one of: the at least one obtained positioning reference signal measurement, or an indication of the at least one obtained positioning reference signal measurement for use in a positioning process for the user equipment.

A computer implemented system comprising: at least one processor and at least one non-transitory memory storing instructions that, when executed by the at least one processor, cause the system at least to perform: causing obtaining of at least one positioning reference signal measurement, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and determining one of: the at least one obtained positioning reference signal measurement, or an indication of the at least one obtained positioning reference signal measurement for use in a positioning process for the user equipment.

A computer implemented system comprising: means for causing obtaining of at least one positioning reference signal measurement, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and means for determining one of: the at least one obtained positioning reference signal measurement, or an indication of the at least one obtained positioning reference signal measurement for use in a positioning process for the user equipment.

In accordance with one example embodiment, an apparatus may comprise: at least one processor; and at least one memory storing instructions that, when executed by the at least one processor, cause the apparatus at least to: obtain at least one positioning reference signal measurement, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and cause a user equipment to determine one of: the at least one obtained positioning reference signal measurement, or an indication of the at least one obtained positioning reference signal measurement for use in a positioning process for the user equipment.

The user equipment may comprise a sidelink user equipment.

The example apparatus may comprise one of: a positioning management entity, a network node, or a location management function.

The example apparatus may be further configured to: receive, from the user equipment, an indication that the at least one positioning reference signal measurement is available at the user equipment; transmit, to the user equipment, a request to provide the at least one positioning reference signal measurement; receive, from the user equipment, the at least one positioning reference signal measurement; analyze the at least one positioning reference signal measurement; and accept one or more of the at least one positioning reference signal measurement.

The example apparatus may be further configured to: transmit, to the user equipment, an acknowledgement of the at least one received positioning reference signal measurement.

The example apparatus may be further configured to: receive, from the user equipment, additional information associated with the at least one positioning reference signal measurement, wherein the additional information may comprise at least one of: a sidelink positioning reference signal configuration, a sidelink positioning reference signal resource identifier, a session identifier, a sidelink positioning reference signal sequence identifier, a measurement quality per sidelink positioning reference signal sequence identifier, a transmit user equipment parameter, or a measurement type.

The example apparatus may be further configured to: determine to hand over a session with the user equipment based, at least partially, on a determination that the user equipment is moving out of the coverage of the apparatus; transmit, to the user equipment, an indication that the at least one positioning reference signal measurement is available at the apparatus; receive, from the user equipment, a request to provide the at least one positioning reference signal measurement; and transmit, to the user equipment, the at least one positioning reference signal measurement.

The example apparatus may be further configured to: transmit, to the user equipment, additional information associated with the at least one positioning reference signal measurement, wherein the additional information may comprise at least one of: a sidelink positioning reference signal configuration, a sidelink positioning reference signal resource identifier, a session identifier, a sidelink positioning reference signal sequence identifier, a measurement quality per sidelink positioning reference signal sequence identifier, a transmit user equipment parameter, or a measurement type.

The example apparatus may be further configured to: receive, from the user equipment, an indication that the user equipment is moving out of the coverage of the apparatus, wherein the determination that the user equipment is moving out of the coverage of the apparatus may be based, at least partially, on the received indication.

In accordance with one aspect, an example method may be provided comprising: obtaining, with a positioning management entity, at least one positioning reference signal measurement, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and causing a user equipment to determine one of: the at least one obtained positioning reference signal measurement, or an indication of the at least one obtained positioning reference signal measurement for use in a positioning process for the user equipment.

The user equipment may comprise a sidelink user equipment.

The positioning management entity may comprise one of: a network node, or a location management function.

The example method may further comprise: receiving, from the user equipment, an indication that the at least one positioning reference signal measurement is available at the user equipment; transmitting, to the user equipment, a request to provide the at least one positioning reference signal measurement; receiving, from the user equipment, the at least one positioning reference signal measurement; analyzing the at least one positioning reference signal measurement; and accepting one or more of the at least one positioning reference signal measurement.

The example method may further comprise: transmitting, to the user equipment, an acknowledgement of the at least one received positioning reference signal measurement.

The example method may further comprise: receiving, from the user equipment, additional information associated with the at least one positioning reference signal measurement, wherein the additional information may comprise at least one of: a sidelink positioning reference signal configuration, a sidelink positioning reference signal resource identifier, a session identifier, a sidelink positioning reference signal sequence identifier, a measurement quality per sidelink positioning reference signal sequence identifier, a transmit user equipment parameter, or a measurement type.

The example method may further comprise: determining to hand over a session with the user equipment based, at least partially, on a determination that the user equipment is moving out of the coverage of the positioning management entity; transmitting, to the user equipment, an indication that the at least one positioning reference signal measurement is available at the positioning management entity; receiving, from the user equipment, a request to provide the at least one positioning reference signal measurement; and transmitting, to the user equipment, the at least one positioning reference signal measurement.

The example method may further comprise: transmitting, to the user equipment, additional information associated with the at least one positioning reference signal measurement, wherein the additional information may comprise at least one of: a sidelink positioning reference signal configuration, a sidelink positioning reference signal resource identifier, a session identifier, a sidelink positioning reference signal sequence identifier, a measurement quality per sidelink positioning reference signal sequence identifier, a transmit user equipment parameter, or a measurement type.

The example method may further comprise: receiving, from the user equipment, an indication that the user equipment is moving out of the coverage of the positioning management entity, wherein the determination that the user equipment is moving out of the coverage of the apparatus may be based, at least partially, on the received indication.

In accordance with one example embodiment, an apparatus may comprise: circuitry configured to perform: obtaining at least one positioning reference signal measurement, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and circuitry configured to perform: causing a user equipment to determine one of: the at least one obtained positioning reference signal measurement, or an indication of the at least one obtained positioning reference signal measurement for use in a positioning process for the user equipment.

In accordance with one example embodiment, an apparatus may comprise: processing circuitry; memory circuitry including computer program code, the memory circuitry and the computer program code configured to, with the processing circuitry, enable the apparatus to: obtain at least one positioning reference signal measurement, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and cause a user equipment to determine one of: the at least one obtained positioning reference signal measurement, or an indication of the at least one obtained positioning reference signal measurement for use in a positioning process for the user equipment.

In accordance with one example embodiment, an apparatus may comprise means for: obtaining at least one positioning reference signal measurement, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and causing a user equipment to determine one of: the at least one obtained positioning reference signal measurement, or an indication of the at least one obtained positioning reference signal measurement for use in a positioning process for the user equipment.

The user equipment may comprise a sidelink user equipment.

The example apparatus may comprise one of: a positioning management entity, a network node, or a location management function.

The means may be further configured for: receiving, from the user equipment, an indication that the at least one positioning reference signal measurement is available at the user equipment; transmitting, to the user equipment, a request to provide the at least one positioning reference signal measurement; receiving, from the user equipment, the at least one positioning reference signal measurement; analyzing the at least one positioning reference signal measurement; and accepting one or more of the at least one positioning reference signal measurement.

The means may be further configured for: transmitting, to the user equipment, an acknowledgement of the at least one received positioning reference signal measurement.

The means may be further configured for: receiving, from the user equipment, additional information associated with the at least one positioning reference signal measurement, wherein the additional information may comprise at least one of: a sidelink positioning reference signal configuration, a sidelink positioning reference signal resource identifier, a session identifier, a sidelink positioning reference signal sequence identifier, a measurement quality per sidelink positioning reference signal sequence identifier, a transmit user equipment parameter, or a measurement type.

The means may be further configured for: determining to hand over a session with the user equipment based, at least partially, on a determination that the user equipment is moving out of the coverage of the apparatus; transmitting, to the user equipment, an indication that the at least one positioning reference signal measurement is available at the apparatus; receiving, from the user equipment, a request to provide the at least one positioning reference signal measurement; and transmitting, to the user equipment, the at least one positioning reference signal measurement.

The means may be further configured for: transmitting, to the user equipment, additional information associated with the at least one positioning reference signal measurement, wherein the additional information may comprise at least one of: a sidelink positioning reference signal configuration, a sidelink positioning reference signal resource identifier, a session identifier, a sidelink positioning reference signal sequence identifier, a measurement quality per sidelink positioning reference signal sequence identifier, a transmit user equipment parameter, or a measurement type.

The means may be further configured for: receiving, from the user equipment, an indication that the user equipment is moving out of the coverage of the apparatus, wherein the determination that the user equipment is moving out of the coverage of the apparatus may be based, at least partially, on the received indication.

In accordance with one example embodiment, a non-transitory computer-readable medium comprising instructions stored thereon which, when executed with at least one processor, cause the at least one processor to: cause obtaining of at least one positioning reference signal measurement, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and cause a user equipment to determine one of: the at least one obtained positioning reference signal measurement, or an indication of the at least one obtained positioning reference signal measurement for use in a positioning process for the user equipment.

In accordance with one example embodiment, a non-transitory computer-readable medium comprising program instructions stored thereon for performing at least the following: causing obtaining of at least one positioning reference signal measurement, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and causing a user equipment to determine one of: the at least one obtained positioning reference signal measurement, or an indication of the at least one obtained positioning reference signal measurement for use in a positioning process for the user equipment.

In accordance with another example embodiment, a non-transitory program storage device readable by a machine may be provided, tangibly embodying instructions executable by the machine for performing operations, the operations comprising: causing obtaining of at least one positioning reference signal measurement, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and causing a user equipment to determine one of: the at least one obtained positioning reference signal measurement, or an indication of the at least one obtained positioning reference signal measurement for use in a positioning process for the user equipment.

In accordance with another example embodiment, a non-transitory computer-readable medium comprising instructions that, when executed by an apparatus, cause the apparatus to perform at least the following: causing obtaining of at least one positioning reference signal measurement, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and causing a user equipment to determine one of: the at least one obtained positioning reference signal measurement, or an indication of the at least one obtained positioning reference signal measurement for use in a positioning process for the user equipment.

A computer implemented system comprising: at least one processor and at least one non-transitory memory storing instructions that, when executed by the at least one processor, cause the system at least to perform: causing obtaining of at least one positioning reference signal measurement, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and causing a user equipment to determine one of: the at least one obtained positioning reference signal measurement, or an indication of the at least one obtained positioning reference signal measurement for use in a positioning process for the user equipment.

A computer implemented system comprising: means for causing obtaining of at least one positioning reference signal measurement, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and means for causing a user equipment to determine one of: the at least one obtained positioning reference signal measurement, or an indication of the at least one obtained positioning reference signal measurement for use in a positioning process for the user equipment.

In accordance with one example embodiment, an apparatus may comprise: at least one processor; and at least one memory storing instructions that, when executed by the at least one processor, cause the apparatus at least to: determine that at least one positioning reference signal measurement is not available, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and transmit an indication that the at least one positioning reference signal measurement is not available to at least one of: a target user equipment, a network node, a location management function, a server user equipment, a further user equipment, or a positioning management entity.

The example apparatus may comprise the target user equipment, and the indication may be transmitted to at least one of: the network node, the location management function, the server user equipment, the further user equipment, or the positioning management entity.

The example apparatus may comprise the positioning management entity, and the indication may be transmitted to the target user equipment.

In accordance with one aspect, an example method may be provided comprising: determining, with an apparatus, that at least one positioning reference signal measurement is not available, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and transmitting an indication that the at least one positioning reference signal measurement is not available to at least one of: a target user equipment, a network node, a location management function, a server user equipment, a further user equipment, or a positioning management entity.

The apparatus may comprise the target user equipment, and the indication may be transmitted to at least one of: the network node, the location management function, the server user equipment, the further user equipment, or the positioning management entity.

The apparatus may comprise the positioning management entity, and the indication may be transmitted to the target user equipment.

In accordance with one example embodiment, an apparatus may comprise: circuitry configured to perform: determining that at least one positioning reference signal measurement is not available, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and circuitry configured to perform: transmitting an indication that the at least one positioning reference signal measurement is not available to at least one of: a target user equipment, a network node, a location management function, a server user equipment, a further user equipment, or a positioning management entity.

In accordance with one example embodiment, an apparatus may comprise: processing circuitry; memory circuitry including computer program code, the memory circuitry and the computer program code configured to, with the processing circuitry, enable the apparatus to: determine that at least one positioning reference signal measurement is not available, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and transmit an indication that the at least one positioning reference signal measurement is not available to at least one of: a target user equipment, a network node, a location management function, a server user equipment, a further user equipment, or a positioning management entity.

In accordance with one example embodiment, an apparatus may comprise means for: determining that at least one positioning reference signal measurement is not available, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and transmitting an indication that the at least one positioning reference signal measurement is not available to at least one of: a target user equipment, a network node, a location management function, a server user equipment, a further user equipment, or a positioning management entity.

The example apparatus may comprise the target user equipment, and the indication may be transmitted to at least one of: the network node, the location management function, the server user equipment, the further user equipment, or the positioning management entity.

The example apparatus may comprise the positioning management entity, and the indication may be transmitted to the target user equipment.

In accordance with one example embodiment, a non-transitory computer-readable medium comprising instructions stored thereon which, when executed with at least one processor, cause the at least one processor to: determine, with an apparatus, that at least one positioning reference signal measurement is not available, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and cause transmitting of an indication that the at least one positioning reference signal measurement is not available to at least one of: a target user equipment, a network node, a location management function, a server user equipment, a further user equipment, or a positioning management entity.

In accordance with one example embodiment, a non-transitory computer-readable medium comprising program instructions stored thereon for performing at least the following: determining, with an apparatus, that at least one positioning reference signal measurement is not available, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and causing transmitting of an indication that the at least one positioning reference signal measurement is not available to at least one of: a target user equipment, a network node, a location management function, a server user equipment, a further user equipment, or a positioning management entity.

In accordance with another example embodiment, a non-transitory program storage device readable by a machine may be provided, tangibly embodying instructions executable by the machine for performing operations, the operations comprising: determining, with an apparatus, that at least one positioning reference signal measurement is not available, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and causing transmitting of an indication that the at least one positioning reference signal measurement is not available to at least one of: a target user equipment, a network node, a location management function, a server user equipment, a further user equipment, or a positioning management entity.

In accordance with another example embodiment, a non-transitory computer-readable medium comprising instructions that, when executed by an apparatus, cause the apparatus to perform at least the following: determining, with an apparatus, that at least one positioning reference signal measurement is not available, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and causing transmitting of an indication that the at least one positioning reference signal measurement is not available to at least one of: a target user equipment, a network node, a location management function, a server user equipment, a further user equipment, or a positioning management entity.

A computer implemented system comprising: at least one processor and at least one non-transitory memory storing instructions that, when executed by the at least one processor, cause the system at least to perform: determining, with an apparatus, that at least one positioning reference signal measurement is not available, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and causing transmitting of an indication that the at least one positioning reference signal measurement is not available to at least one of: a target user equipment, a network node, a location management function, a server user equipment, a further user equipment, or a positioning management entity.

A computer implemented system comprising: means for determining, with an apparatus, that at least one positioning reference signal measurement is not available, wherein the at least one positioning reference signal measurement may comprise at least one of: a positioning reference signal measurement from a session-less positioning process, a positioning reference signal measurement from a past positioning process, or a positioning reference signal measurement from a parallel positioning process; and means for causing transmitting of an indication that the at least one positioning reference signal measurement is not available to at least one of: a target user equipment, a network node, a location management function, a server user equipment, a further user equipment, or a positioning management entity.

In accordance with one example embodiment, an apparatus may comprise: at least one processor; and at least one memory storing instructions that, when executed by the at least one processor, cause the apparatus at least to: determine that a positioning process of a target user equipment is changed; and obtain at least one positioning reference signal measurement associated with the target user equipment, wherein the at least one positioning reference signal measurement may comprise at least one of: a positioning reference signal measurement from a session-less positioning process, a positioning reference signal measurement from a past positioning process, or a positioning reference signal measurement from a parallel positioning process.

In accordance with one aspect, an example method may be provided comprising: determining, with a server user equipment, that a positioning process of a target user equipment is changed; and obtaining at least one positioning reference signal measurement associated with the target user equipment, wherein the at least one positioning reference signal measurement may comprise at least one of: a positioning reference signal measurement from a session-less positioning process, a positioning reference signal measurement from a past positioning process, or a positioning reference signal measurement from a parallel positioning process.

In accordance with one example embodiment, an apparatus may comprise: circuitry configured to perform: determining that a positioning process of a target user equipment is changed; and circuitry configured to perform: obtaining at least one positioning reference signal measurement associated with the target user equipment, wherein the at least one positioning reference signal measurement may comprise at least one of: a positioning reference signal measurement from a session-less positioning process, a positioning reference signal measurement from a past positioning process, or a positioning reference signal measurement from a parallel positioning process.

In accordance with one example embodiment, an apparatus may comprise: processing circuitry; memory circuitry including computer program code, the memory circuitry and the computer program code configured to, with the processing circuitry, enable the apparatus to: determine that a positioning process of a target user equipment is changed; and obtain at least one positioning reference signal measurement associated with the target user equipment, wherein the at least one positioning reference signal measurement may comprise at least one of: a positioning reference signal measurement from a session-less positioning process, a positioning reference signal measurement from a past positioning process, or a positioning reference signal measurement from a parallel positioning process.

In accordance with one example embodiment, an apparatus may comprise means for: determining that a positioning process of a target user equipment is changed; and obtaining at least one positioning reference signal measurement associated with the target user equipment, wherein the at least one positioning reference signal measurement may comprise at least one of: a positioning reference signal measurement from a session-less positioning process, a positioning reference signal measurement from a past positioning process, or a positioning reference signal measurement from a parallel positioning process.

In accordance with one example embodiment, a non-transitory computer-readable medium comprising instructions stored thereon which, when executed with at least one processor, cause the at least one processor to: determine that a positioning process of a target user equipment is changed; and cause obtaining of at least one positioning reference signal measurement associated with the target user equipment, wherein the at least one positioning reference signal measurement may comprise at least one of: a positioning reference signal measurement from a session-less positioning process, a positioning reference signal measurement from a past positioning process, or a positioning reference signal measurement from a parallel positioning process.

In accordance with one example embodiment, a non-transitory computer-readable medium comprising program instructions stored thereon for performing at least the following: determining that a positioning process of a target user equipment is changed; and causing obtaining of at least one positioning reference signal measurement associated with the target user equipment, wherein the at least one positioning reference signal measurement may comprise at least one of: a positioning reference signal measurement from a session-less positioning process, a positioning reference signal measurement from a past positioning process, or a positioning reference signal measurement from a parallel positioning process.

In accordance with another example embodiment, a non-transitory program storage device readable by a machine may be provided, tangibly embodying instructions executable by the machine for performing operations, the operations comprising: determining that a positioning process of a target user equipment is changed; and causing obtaining of at least one positioning reference signal measurement associated with the target user equipment, wherein the at least one positioning reference signal measurement may comprise at least one of: a positioning reference signal measurement from a session-less positioning process, a positioning reference signal measurement from a past positioning process, or a positioning reference signal measurement from a parallel positioning process.

In accordance with another example embodiment, a non-transitory computer-readable medium comprising instructions that, when executed by an apparatus, cause the apparatus to perform at least the following: determining that a positioning process of a target user equipment is changed; and causing obtaining of at least one positioning reference signal measurement associated with the target user equipment, wherein the at least one positioning reference signal measurement may comprise at least one of: a positioning reference signal measurement from a session-less positioning process, a positioning reference signal measurement from a past positioning process, or a positioning reference signal measurement from a parallel positioning process.

A computer implemented system comprising: at least one processor and at least one non-transitory memory storing instructions that, when executed by the at least one processor, cause the system at least to perform: determining that a positioning process of a target user equipment is changed; and causing obtaining of at least one positioning reference signal measurement associated with the target user equipment, wherein the at least one positioning reference signal measurement may comprise at least one of: a positioning reference signal measurement from a session-less positioning process, a positioning reference signal measurement from a past positioning process, or a positioning reference signal measurement from a parallel positioning process.

A computer implemented system comprising: means for determining that a positioning process of a target user equipment is changed; and means for causing obtaining of at least one positioning reference signal measurement associated with the target user equipment, wherein the at least one positioning reference signal measurement may comprise at least one of: a positioning reference signal measurement from a session-less positioning process, a positioning reference signal measurement from a past positioning process, or a positioning reference signal measurement from a parallel positioning process.

The term “non-transitory,” as used herein, is a limitation of the medium itself (i.e. tangible, not a signal) as opposed to a limitation on data storage persistency (e.g., RAM vs. ROM).

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

What is claimed is:

1. An apparatus comprising:
at least one processor; and
at least one non-transitory memory storing instructions that, when executed by the
at least one processor, cause the apparatus at least to:
obtain at least one positioning reference signal measurement, wherein the at least one positioning reference signal measurement comprises at least one of:
a positioning reference signal measurement from a session-less positioning process,
a positioning reference signal measurement from a past positioning process, or
a positioning reference signal measurement from a parallel positioning process; and
determine one of:
the at least one obtained positioning reference signal measurement, or
an indication of the at least one obtained positioning reference signal measurement
for use in a positioning process for the apparatus.

2. The apparatus of claim 1, wherein the apparatus comprises a sidelink user equipment.

3. The apparatus of claim 1, wherein the at least one memory stores instructions that, when executed by the at least one processor, cause the apparatus to:
transmit, to a positioning entity, an indication that the at least one positioning reference signal measurement is available at the apparatus;
receive, from the positioning entity, a request to provide the at least one positioning reference signal measurement; and
transmit, to the positioning entity, the at least one positioning reference signal measurement.

4. The apparatus of claim 3, wherein the positioning entity comprises at least one of:
a network node,
a location management function,
a server user equipment,
a further user equipment, or
a positioning management entity.

5. The apparatus of claim 3, wherein the at least one memory stores instructions that, when executed by the at least one processor, cause the apparatus to:
receive, from the positioning entity, an acknowledgement of the at least one transmitted positioning reference signal measurement.

6. The apparatus of claim 3, wherein the at least one memory stores instructions that, when executed by the at least one processor, cause the apparatus to:
overhear at least one positioning reference signal;
perform the session-less positioning process based, at least partially, on the overheard positioning reference signal; and
determine that an accuracy of the session-less positioning process does not meet at least one requirement, wherein the indication that the at least one positioning reference signal measurement is available at the apparatus is transmitted in response to the accuracy of the session-less positioning process not meeting the at least one requirement.

7. The apparatus of claim 3, wherein the positioning process comprises a session-based positioning process.

8. The apparatus of claim 3, wherein the at least one memory stores instructions that, when executed by the at least one processor, cause the apparatus to:
transmit, to the positioning entity, additional information associated with the at least one positioning reference signal measurement, wherein the additional information comprises at least one of:
a sidelink positioning reference signal configuration,
a sidelink positioning reference signal resource identifier,
a session identifier,
a sidelink positioning reference signal sequence identifier,
a measurement quality per sidelink positioning reference signal sequence identifier,
a transmit user equipment parameter, or
a measurement type.

9. The apparatus of claim 1, wherein the at least one memory stores instructions that, when executed by the at least one processor, cause the apparatus to:
perform a session-based positioning process;
receive, from a positioning entity, an indication that the at least one positioning reference signal measurement is available at the network node;
transmit, to the positioning entity, a request to provide the at least one positioning reference signal measurement; and
receive, from the positioning entity, the at least one positioning reference signal measurement.

10. The apparatus of claim 9, wherein the positioning entity comprises at least one of:
a network node,
a location management function,
a server user equipment,
a further user equipment, or
a positioning management entity.

11. The apparatus of claim 9, wherein the positioning process comprises a subsequent session-based positioning process.

12. The apparatus of claim 9, wherein the positioning process comprises a session-less positioning process.

13. The apparatus of claim 9, wherein the at least one memory stores instructions that, when executed by the at least one processor, cause the apparatus to:
receive, from the positioning entity, additional information associated with the at least one positioning reference signal measurement, wherein the additional information comprises at least one of:
a sidelink positioning reference signal configuration,
a sidelink positioning reference signal resource identifier,
a session identifier,
a sidelink positioning reference signal sequence identifier,
a measurement quality per sidelink positioning reference signal sequence identifier,
a transmit user equipment parameter, or
a measurement type.

14. The apparatus of claim 9, wherein the at least one memory stores instructions that, when executed by the at least one processor, cause the apparatus to:
provide the at least one obtained positioning reference signal measurement to a server user equipment.

15. The apparatus of claim 9, wherein the at least one memory stores instructions that, when executed by the at least one processor, cause the apparatus to:
transmit, to the positioning entity, an indication that the apparatus is moving out of the coverage of the positioning entity.

16. The apparatus of claim 1, wherein the at least one memory stores instructions that, when executed by the at least one processor, cause the apparatus to:
trigger the positioning process based, at least partially, on the at least one obtained positioning reference signal measurement.

17. The apparatus of claim 1, wherein the at least one memory stores instructions that, when executed by the at least one processor, cause the apparatus to:
select at least one complementary anchor user equipment based, at least partially, on the at least one obtained positioning reference signal measurement.

18. The apparatus of claim 1, wherein the at least one memory stores instructions that, when executed by the at least one processor, cause the apparatus to at least one of:
accept one or more of the at least one positioning reference signal measurement; or
reject one or more of the at least one positioning reference signal measurement.

19. An apparatus comprising:
at least one processor; and
at least one non-transitory memory storing instructions that, when executed by the at least one processor, cause the apparatus at least to:
obtain at least one positioning reference signal measurement, wherein the at least one positioning reference signal measurement comprises at least one of:
a positioning reference signal measurement from a session-less positioning process,
a positioning reference signal measurement from a past positioning process, or
a positioning reference signal measurement from a parallel positioning process; and
cause a user equipment to determine one of:
the at least one obtained positioning reference signal measurement, or
an indication of the at least one obtained positioning reference signal measurement
for use in a positioning process for the user equipment.

20. An apparatus comprising:
at least one processor; and
at least one non-transitory memory storing instructions that, when executed by the at least one processor, cause the apparatus at least to:
determine that at least one positioning reference signal measurement is not available, wherein the at least one positioning reference signal measurement comprises at least one of:
a positioning reference signal measurement from a session-less positioning process,
a positioning reference signal measurement from a past positioning process, or
a positioning reference signal measurement from a parallel positioning process; and
transmit an indication that the at least one positioning reference signal measurement is not available to at least one of:
a target user equipment,
a network node.
a location management function.
a server user equipment.
a further user equipment, or
a positioning management entity.
